(19) United States
(12) Patent Application Publication
(10) Pub. No.: US 2015/0314713 A1
(43) Pub. Date: Nov. 5, 2015

(54) Vehicle Seat

(71) Applicant: LUFTHANSA TECHNIK AG, Hamburg (DE)

(72) Inventors: Oliver THOMASCHEWSKI, Norderstedt (DE); Jacques PIERREJEAN, Pietrosella (FR)

(21) Appl. No.: 14/655,269

(22) PCT Filed: Dec. 23, 2013
(86) PCT No.: PCT/EP2013/077887

§ 371 Date: Jun. 24, 2015

(30) Foreign Application Priority Data
Dec. 24, 2012 (DE) 10 2012 224 358.5

(51) Int. Cl. B60N 2/46; B64D 11/00; B64D 11/06

(52) U.S. Cl. CPC B60N 2/468; B64D 11/0646; B64D 11/0638; B64D 11/0015

(57) ABSTRACT

The invention relates to a vehicle seat (1), which comprises at least one recess (12) and one movable carrier platform (3), wherein the carrier platform (3) can be moved out of a park position into a use position. The carrier platform (3) comprises a mechanical connector (4), wherein the carrier platform (3) is held in the recess (12) when in the park position, wherein, in the use position, on the carrier platform (3), a carrier module (5) comprising a mechanical connection device (6) can be connected to the connector (4) of the carrier platform (3).

The invention relates to a vehicle seat.

Vehicle seats, for example in aircraft, typically have various functionalities in the surroundings thereof, which functionalities can be used by a passenger who is sitting in the vehicle seat. Such functionalities can be for example tray tables, cup holders, screens or additional holders which can be used by the passenger during the journey. The corresponding appliances or devices for implementing the functionalities are generally attached to adjacent vehicle seats or to the vehicle seat itself.

In various cabin layouts, the vehicle seat is spatially arranged at a relatively large distance from other vehicle seats in the cabin of a vehicle. This is the case for example in VIP layouts of aircraft, where it is not possible to use adjacent vehicle seats for the placement of the various functionalities. Therefore, kinematics are conventionally used so that for example a table can be folded out of the armrest. The ability to implement a plurality of functionalities on the vehicle seat or in the region thereof therefore remains comparatively restricted. Furthermore, vehicle seats comprising several add-ons for implementing the various functionalities end up having a bulky appearance in order to be able to receive the various kinematics, but this is undesirable from an aesthetic point of view.

The object of the invention is to disclose a vehicle seat which overcomes the above-mentioned disadvantages.

The object of the invention is achieved by the features of claim 1. A vehicle seat is proposed wherein the vehicle seat comprises at least one recess and one movable carrier platform, wherein the carrier platform can be moved from a park position into a use position, wherein the carrier platform is held in the recess when in the park position. The carrier platform further comprises a mechanical connector. In the use position, on the carrier platform, a carrier module comprising a mechanical connection device can be connected to the connector of the carrier platform.

The attachable carrier module allows for a plurality of functionalities which can be connected to the vehicle seat and which can be changed, modernised or adapted to special requirements in a simple manner. In this case, the vehicle seat can be kept the same regardless of changing requirements, and this can lead to a simplified construction and an advantage in terms of cost. With regard to safety, the removable carrier module allows a great degree of design freedom in the region of the seat, since the carrier module can be removed when in use in aircraft during transition into critical flight phases, such as take-off, landing or taxiing, and thus does not affect the safety of a passenger sitting in the vehicle seat in the event of an incident. The park position of the carrier platform is also used to increase safety in such flight phases, since the passenger cannot come into undesired mechanical contact with the carrier platform, which is concealed in the recess in the armrest. In addition, the two positions of the carrier platform allow for an aesthetically pleasing contour of the vehicle seat when the carrier modules are not attached. In particular, the outside of the carrier platform can be shaped such that the outside of the carrier platform, when in the park position, complements the external shape to form a harmonious, in particular continuous curve.

The attachable and removable carrier modules having different functionalities are suitable in particular for changing requirements of a passenger during a journey. This can advantageously be used in the case of VIP transport, since there is often more seating space available, which prevents the conventional use of surrounding seats or parts of the cabin for attaching functionalities. The various carrier modules can be changed for example by the cabin crew during the flight. The carrier modules which are not in use can be stowed away easily, in particular in a VIP cabin having a smaller number of passengers.

In an advantageous embodiment, the connection device can be attached for example to the connector in the form of a plug connection. Alternatively, clamp, clip or screw connections and additional detachable mechanical connections can also be used.

Preferably, the vehicle seat comprises at least one armrest, wherein at least one recess and one movable carrier platform are arranged on or in an armrest. An armrest advantageously makes it possible to position a recess with the corresponding movable carrier platform on a vehicle seat. The corresponding installation space can be provided in an armrest on the vehicle seat in a simple manner.

Furthermore, in the park position, the carrier platform can preferably be inserted at least far enough into the recess that the mechanical connector is covered. The carrier platform is therefore concealed in the recess at least to the extent that the connector is not visible and carrier modules cannot be attached. Therefore, once it has been unlocked, the carrier platform can preferably be grasped by an operator or passenger and moved into a use position. In additional advantageous embodiments, the carrier platform can be completely concealed or covered in the park position.

Advantageously, the connection device of a carrier module can be connected to the connector of the carrier platform in a rotatable manner. The rotatable connection allows for advantageous pivoting movements so that the carrier module can be adjusted by a passenger according to his body proportions and sitting position. The combination of the mechanical connection of the connection device and the connector and a resulting pivot joint allows for a simple and easy construction, since there is no need to provide a separate pivot joint in order to achieve an adjustment capability of this type for the passenger. In addition, it is thus possible to connect the carrier module to the carrier platform in various rotary positions or angular positions, which is advantageous in particular if the cabin crew connects said module from the side when the passenger is sitting in the vehicle seat. The rotation between the carrier module and the carrier platform preferably has sufficient friction to prevent undesired rotation of the carrier module during normal movements of the vehicle.

In preferred embodiments, in the use position, at least one carrier platform projects out of the armrest in the direction of the seat. This is an advantageous arrangement so that the carrier platform is ergonomically located within convenient reach of the hand of a person sitting in a conventional sitting position.

In addition, in the use position, at least one carrier platform preferably projects out of the armrest in the opposite direction to the seat. Such an arrangement is advantageous when the vehicle seat is in a reclined position, when the backrest is folded right back in the opposite direction to the seat, and the passenger is in a reclined position in the vehicle seat. A carrier module on a carrier platform that is positioned in this manner can be reached or seen by the passenger without raising his upper body out of the reclined position.

Preferably, the carrier module can be connected to an electric power supply circuit via the connector and the connection device of the carrier module. The carrier module itself can therefore comprise an electric load, such as a lamp. Moreover, a connector or a holder of an electrical or electronic device can be provided on the carrier module, which device can be operated for long periods of time by the passenger by means of the electric power supply circuit. The power supply circuit can be provided for example by the vehicle or aircraft. A preferred supply voltage of the power supply circuit is a DC voltage of 5 V. In addition, in an advantageous embodiment, various control signals can be transmitted to the carrier module as an alternative to, in addition to or alternately with the connection to the electric power supply circuit.

In an advantageous embodiment, at least two electric sliding contacts can be closed between the connector and the connection device. The sliding contacts allow for simple power transmission and/or data transmission, in particular in the case of a rotation of the carrier module relative to the carrier platform, so that an additional connection procedure using plugs can be avoided when connecting or changing a carrier module.

In advantageous embodiments, the carrier module comprises a tray and/or a drinks holder and/or a book holder. In this way, the passenger in the vehicle can be provided with appropriate functionalities without incorporating an adjacent seat or part of the cabin.

Appropriate carrier modules can be changed during the journey according to the passenger's wishes.

In additional advantageous embodiments, the carrier module comprises a telephone holder and/or a screen holder and/or a screen. The screen holder can preferably also hold devices which can be controlled primarily via the screen thereof, such as tablet computers. Such holders are advantageous because they are difficult to hold in the hand for relatively long periods of time and, in VIP cabins, for example of an aircraft, there is little opportunity to provide the passenger with a relatively small, seat-mounted screen due to the large spaces between the seats.

Preferably, a storage space is provided on the vehicle seat for at least one carrier module. The carrier modules are necessarily stored away when not in use, inter alia during take-off and landing procedures. In principle, the storage can take place anywhere in the cabin, but a storage space is advantageously provided on the vehicle seat, for example on the armrests or under the vehicle seat, in order to also make various carrier modules available to the passengers themselves at short notice.

The invention will be described below on the basis of preferred embodiments and with reference to the accompanying drawings, in which:

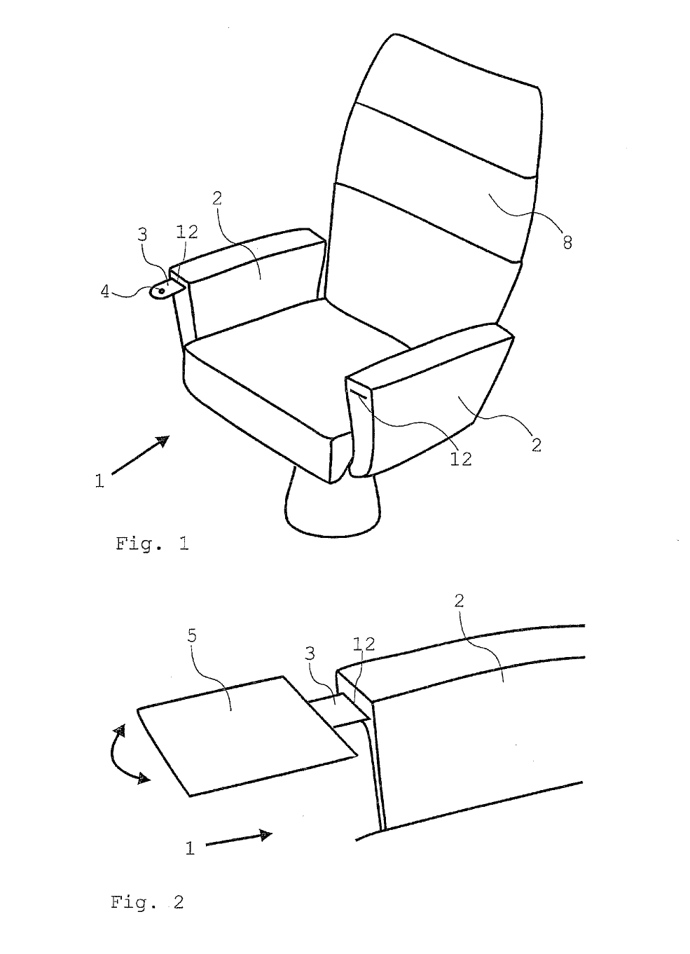

FIG. 1 shows a vehicle seat comprising a carrier platform in a park position and a carrier platform in a use position;

FIG. 2 shows an armrest comprising an attached carrier module as a tray;

FIG. 3 shows an armrest comprising a carrier platform and a carrier module comprising a transparent tray;

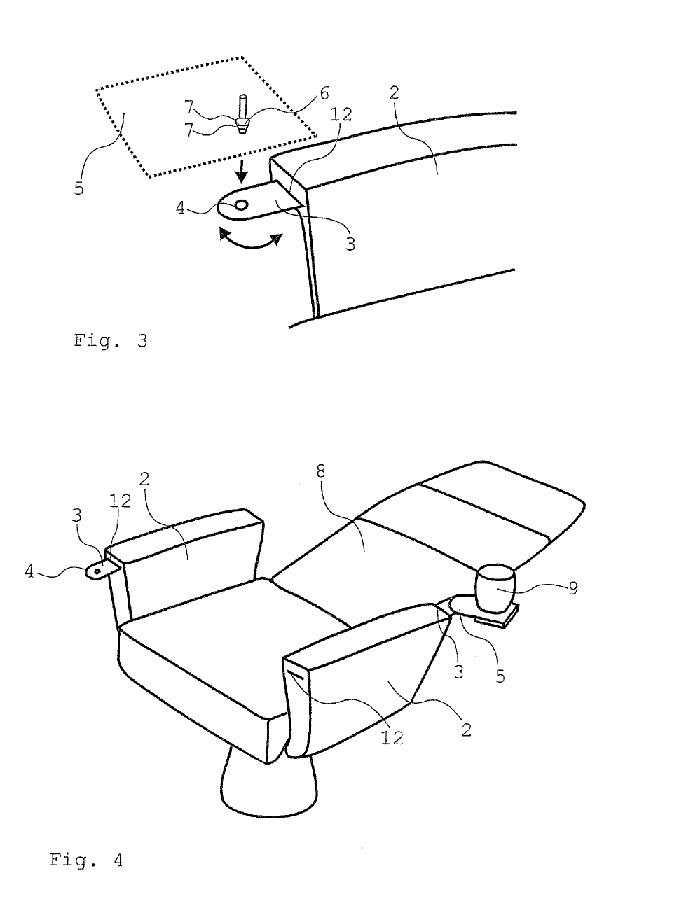

FIG. 4 shows a vehicle seat in a reclined position comprising a carrier platform projecting in the opposite direction to the seat and having an attached carrier module;

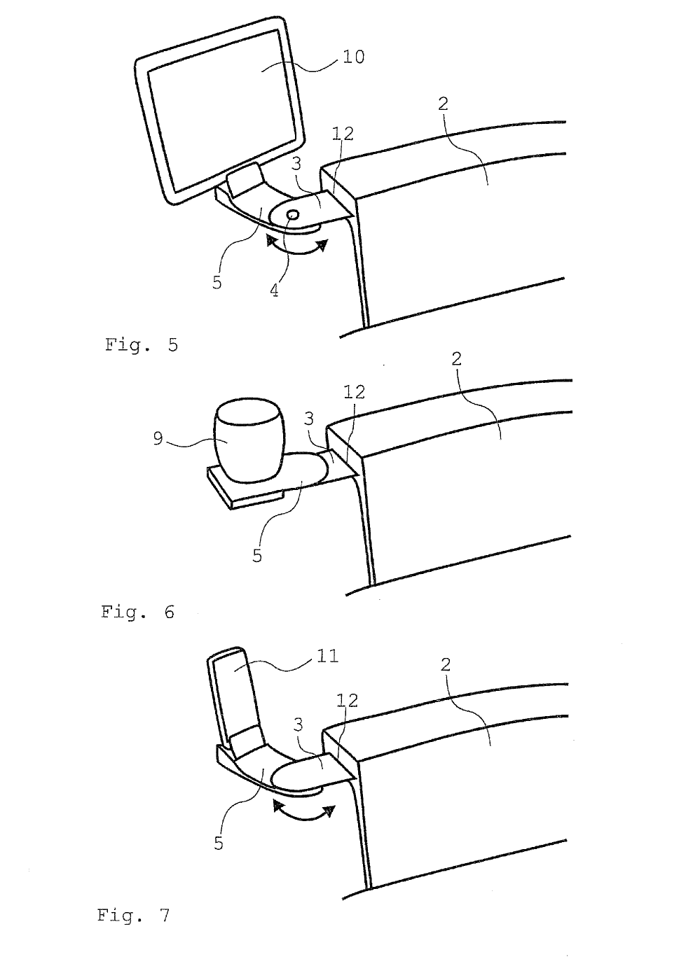

FIG. 5 shows an armrest comprising a rotatable carrier module having a screen holder;

FIG. 6 shows an armrest comprising a rotatable carrier module having a drinks holder; and

FIG. 7 shows an armrest comprising a carrier module having a telephone holder.

FIG. 1 shows an advantageous embodiment of a vehicle seat 1. The vehicle seat 1 has two armrests 2, in each of which a carrier platform 3 is integrated. In the armrest 2 which is on the right in the direction of the seat (the higher armrest in the view in FIG. 1), the carrier platform 3 is in a use position, in which the carrier platform 3 projects out of the armrest 2 in the direction of the seat.

In this embodiment, no carrier module 5 is connected to the carrier platform 3, and therefore the connector 4 for mechanically connecting a carrier module 5 can be seen. The connector 4 can be for example in the form of a round opening.

The left-hand carrier platform 3 is in a park position and is retracted into the recess 12 in the left-hand armrest 2 so that it does not project substantially beyond the contour of the armrest 2.

In preferred embodiments, the carrier platform 3 can therefore be extended out of the recess 12 in a linear and preferably horizontal manner, wherein differently shaped movement paths between the park position and the use position can also be used. In the park position and/or in the use position, locking can be provided which makes it possible to fix the carrier platform 3 so that such a position can be maintained even in the face of certain mechanical loads.

The movement between the individual locked positions can be carried out by an operator for example by means of a button or a lever. In possible embodiments, the carrier platform can be spring-loaded, and can therefore move automatically from one locked position into another when a lock is released. The other direction of movement can be carried out for example by an operator. In additional embodiments, a change between the locked positions or between the park and use positions can be carried out by means of an electric and/or pneumatic drive.

In FIG. 2, a possible carrier module 5 is placed on the carrier platform 3 in the form of a tray. In this case, the tray can be pivoted about a vertical axis so that it can be pivoted in front of the upper body of a passenger or can be turned away to the side of the vehicle seat 1, for example in order to allow the passenger to stand up.

FIG. 3 shows a comparable carrier module 5 such as in FIG. 2, wherein in this embodiment, the main panel of the tray is designed to be transparent so that the mechanical connection device 6 of the carrier module 5 can be seen. In this embodiment, the carrier module 5 can thus be placed onto the carrier platform 3 from above so that the connection device 6 can be inserted in the connector 4. In advantageous embodiments, this connection is secured against undesired release. The connection device 6 is advantageously designed to be rotationally symmetrical so that the carrier module 5 can easily be rotated relative to the carrier platform 3.

In addition, in the embodiment in FIG. 3, two slip rings 7 can be seen which are used to connect the carrier module 5 to an electric power supply circuit. In the specific embodiment in FIG. 3, for example illumination of the transparent tray can be produced.

FIG. 4 shows a vehicle seat 1, the backrest 8 of which has been moved into a flat reclined position. The vehicle seat 1 comprises a carrier platform 3 which, in the use position thereof, projects in the opposite direction to the seat, in this embodiment out of the left-hand armrest 2 (the lower armrest in the view in FIG. 4). For example a carrier module 5 comprising a drinks holder can be arranged on the carrier platform 3, on which holder a drinking vessel 9 can be placed safely. In this arrangement of a carrier platform 3 which can be pulled backwards out of the armrest 2, a passenger in the reclined position can comfortably use the amenity, in this case the drinking vessel. In this case, the passenger does not have to sit up to use the functionality of the carrier module 5. In this case, a park position is also advantageous, since a carrier platform 3 placed in this manner would spoil the overall appearance in the case of an upright sitting position and would additionally be in the way when for example cabin crew pass behind the vehicle seat 1.

In FIG. 5, a possible embodiment of a carrier module 5 is shown, which comprises a screen holder. In this case, the screen is a tablet computer 10 which can be fixed to the screen holder, wherein the screen of the tablet computer 10 can be seen and optionally operated by the passenger in the vehicle seat 1. In addition, in this embodiment, the carrier module 5 is inserted into the carrier platform 3 from below, which makes it different from the embodiments described above. In possible advantageous embodiments, the connector 4 allows for attachment of a connection device 6 from above and/or from below.

FIG. 6 shows an additional embodiment of a carrier module 5 comprising a drinks holder, which, in contrast with the embodiment in FIG. 3, is attached to a carrier platform 3 which is oriented in the direction of the seat so that the drinks holder is easy for a passenger to reach when he is in an upright sitting position. Therefore, the same carrier module 5 can be used when the vehicle seat 1 is used whilst reclined or sitting, wherein the carrier module 5 is attached from one carrier platform 3 to another carrier platform 3.

FIG. 7 shows a carrier module 5 comprising a telephone holder, to which a smartphone 11 is fixed. In advantageous embodiments, the carrier module 5 is connected to a power supply circuit of the vehicle or aircraft, so that in the telephone holder of the carrier module 5, the smartphone 11 can be supplied with a DC voltage of 5 V.

1-11. (canceled)

12. A vehicle seat, comprising:
at least one recess; and
a corresponding at least one carrier platform,
wherein each carrier platform of the at least one carrier platform is movable from a corresponding park position to a corresponding use position, and from the use position to the park position, with respect to the corresponding recess of the at least one recess,
wherein each carrier platform of the at least one carrier platform is held in the corresponding recess of the at least one recess when in the park position,
wherein each carrier platform of the at least one carrier platform comprises:
a corresponding mechanical connector,
wherein when each carrier platform of the at least one carrier platform is in the use position, a carrier module having a mechanical connection device is connectable to the carrier platform via the mechanical connection device of the carrier module connecting to the corresponding mechanical connector of the carrier platform.

13. The vehicle seat according to claim 12,
wherein the vehicle seat comprises one or more armrests, wherein the at least one recess is arranged on or in the one or more armrests, such that each recess of the at least one recess is arranged on or in a corresponding armrest of the one or more armrests and the carrier platform corresponding to the recess is arranged on or in the corresponding armrest of the one or more armrests.

14. The vehicle seat according to claim 13,
wherein when one or more carrier platforms of the at least one carrier platform are in the corresponding one or more use positions, the one or more carrier platforms of the at least one carrier platform project out of the corresponding armrest(s) of the one or more armrests that the one or more carrier platforms are arranged on or in, in a direction the vehicle seat faces.

15. The vehicle seat according to claim 14,
wherein when a second one or more of the at least one carrier platform are in the corresponding one or more use positions, the second one or more carrier platforms of the at least one carrier platform project out of the corresponding armrest(s) of the one or more armrests that the second one or more carrier platforms are arranged on or in, in a direction opposite to the direction the vehicle seat faces.

16. The vehicle seat according to claim 13,
wherein when one or more carrier platforms of the at least one carrier platform are in the corresponding one or more use positions, the one or more carrier platforms of the at least one carrier platform project out of the corresponding armrest(s) of the one or more armrests that the one or more carrier platforms are arranged on or in, in a direction opposite to a direction the vehicle seat faces.

17. The vehicle seat according to claim 1,
wherein when the at least one carrier platform is in the corresponding at least one park position, each carrier platform of the at least one carrier platform is inserted at least far enough into the corresponding recess the carrier platform is arranged on or in, that the corresponding mechanical connector of the carrier platform is covered.

18. The vehicle seat according to claim 1,
wherein when each carrier platform of the at least one carrier platform is in the use position the carrier module is connectable to the carrier platform in a rotatable manner via the mechanical connection device of the carrier module connecting to the mechanical connector of the carrier platform.

19. The vehicle seat according to claim 1,
wherein when each carrier platform of the at least one carrier platform is in the use position the carrier module is connectable to the carrier platform via the mechanical connection device of the carrier module connecting to the corresponding mechanical connector of the carrier platform, such that the carrier module is connected to an electric power supply circuit.

20. The vehicle seat according to claim 19,
wherein when the carrier module is connected to the carrier platform via the mechanical connection device of the carrier module connecting to the corresponding mechanical connector of the carrier platform, at least two electric sliding contacts are closed between the mechanical connector of the carrier platform and the mechanical connection device of the carrier module.

21. The vehicle seat according to claim 1,
wherein the carrier module comprises one or more of the following:
a tray, a drink holder, and a book holder.

22. The vehicle seat according to claim 1,
wherein the carrier module comprises one or more of the following:
a telephone holder, a screen holder, and a screen.

23. The vehicle seat according to claim 1,
wherein the vehicle seat comprises a storage space,
wherein the storage space is configured to store the carrier module.

24. The vehicle seat according to claim 23,
wherein the storage space is configured to store at least one additional carrier module.

25. The vehicle seat according to claim 1,
wherein the vehicle seat comprises the carrier module.

26. The vehicle seat according to claim 25,
wherein the vehicle seat comprises at least one additional carrier module.

27. The vehicle seat according to claim 1,
wherein when each carrier platform of the at least one carrier platform is in the use position the carrier module is connectable to the carrier module via the mechanical connection device of the carrier module connecting to the corresponding mechanical connector of the carrier platform, such that the carrier module is connected to the carrier platform in a manner to allow data transmission to and from the carrier module via the carrier platform.

28. A method of providing a carrier module to a user in a vehicle seat, comprising:
providing a vehicle seat, wherein the vehicle seat comprises:
at least one recess; and
a corresponding at least one carrier platform,
wherein each carrier platform of the at least one carrier platform is movable from a corresponding park position to a corresponding use position, and from the use position to the park position, with respect to the corresponding recess of the at least one recess,
wherein each carrier platform of the at least one carrier platform is held in the corresponding recess of the at least one recess when in the park position,
wherein each carrier platform of the at least one carrier platform comprises:
a corresponding mechanical connector,
wherein when each carrier platform of the at least one carrier platform is in the use position, a carrier module having a mechanical connection device is connectable to the carrier platform via the mechanical connection device of the carrier module connecting to the corresponding mechanical connector of the carrier platform; and
connecting the carrier module to a first carrier platform of the at least one carrier platform when the first carrier platform is in the use position, such that a user seated in the vehicle seat has access to the carrier module.

29. The method according to claim 28,
wherein providing the vehicle seat comprises providing the vehicle seat in a vehicle.

30. The method according to claim 29,
wherein the vehicle is an aircraft.

31. The method according to claim 28,
wherein the vehicle seat comprises one or more armrests,
wherein the at least one recess is arranged on or in the one or more armrests, such that each recess of the at least one recess is arranged on or in a corresponding armrest of the one or more armrests and the carrier platform corresponding to the recess is arranged on or in the corresponding armrest of the one or more armrests,
wherein when the first carrier platform of the at least one carrier platform is in the use position, the first carrier platform projects out of the corresponding armrest of the one or more armrests the first carrier platform is arranged on or in, in a direction the vehicle seat faces,
wherein the method further comprises:
removing the carrier module from the first carrier platform; and
connecting the carrier module to a second carrier platform when the second carrier platform is in the use position,
wherein when the second carrier platform of the at least one carrier platform is in the use position, the second carrier platform projects out of the corresponding armrest of the one or more armrests the second carrier platform is arranged on or in, in a direction opposite to the direction the vehicle scat faces.
